(19) United States
(12) Patent Application Publication
(10) Pub. No.: US 2008/0112493 A1
(43) Pub. Date: May 15, 2008

(54) Method and System for Recursively Detecting MIMO Signals

(76) Inventor: Emmanouil Frantzeskakis, Ilioupolis (GR)

Correspondence Address: MCANDREWS HELD & MALLOY, LTD, 500 WEST MADISON STREET, SUITE 3400, CHICAGO, IL, 60661, US

(21) Appl. No.: 11/559,261

(22) Filed: Nov. 13, 2006

(51) Int. Cl. H04L 27/28

(52) U.S. Cl. 375/260

(57) ABSTRACT

A method and system for recursively detecting MIMO signals is provided. The method may include receiving an RF vector signal comprising a plurality of transmitted subcarriers and determining an estimate of the received RF vector signal in a recursive manner on a per symbol or even a per sample basis. The method may also include normalizing a plurality of the transmitted subcarriers utilizing at least one subcarrier normalizer before performing the recursive algorithm. A systolic array may be used to process the multi-antenna received data in parallel and the state variables of the systolic array may be stored to a memory before processing the next subcarrier. The receiver and transmitter may be part of a MIMO system, where a beam-forming matrix may be communicated from the receiver to the transmitter, and the signals may conform to an OFDM standard.

### CROSS-REFERENCE TO RELATED APPLICATIONS/INCORPORATION BY REFERENCE

Not Applicable.

### FIELD OF THE INVENTION

Certain embodiments of the invention relate to communication systems. More specifically, certain embodiments of the invention relate to a method and system for recursively detecting MIMO signals.

### BACKGROUND OF THE INVENTION

Mobile communications has changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the data connections, such as the mobile Internet, for example, is the next step in the mobile communication revolution. The mobile Internet is poised to become a common source of everyday information, and easy, versatile mobile access to this data will be taken for granted.

Third generation (3G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink throughput and, in turn, offer advanced QoS capabilities and speeds that rival those delivered by cable modem and/or DSL service providers. In this regard, networks based on orthogonal frequency division multiplexing (OFDM) and multi-input/multi-output (MIMO) technology may make the delivery of data to end-users a more feasible option for today's wireless carriers.

However, as in most RF systems, the distortions produced by the communication channel may degrade the performance of such systems. One way this problem may be mitigated may be to insert known preambles into a transmitted data burst. A receiver may then be able to determine the channel characteristics by comparing the received preamble with a preamble stored in a memory and may then subsequently compensate for the distortions produced by the channel. This method may work well under static conditions, where the transmitting and receiving units are stationary relative to one another. However, under dynamic conditions, such as a mobile terminal in a speeding car, the channel characteristics may change too fast for such systems to compensate. As a result voice communication may be impaired. Or even worse, packets of data in a data communication session may be lost.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for recursively detecting MIMO signals, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for transmitting OFDM signals, which may be utilized in connection with an embodiment of the invention.

FIG. 1B is a block diagram of an exemplary system for receiving OFDM signals, in accordance with an embodiment of the invention.

FIG. 2A is a block diagram of an exemplary systolic array, which may be utilized in connection with an embodiment of the invention.

FIG. 2B is a block diagram of an exemplary systolic array that produces weight vectors, which may be utilized in connection with an embodiment of the invention.

FIG. 3A is a block diagram of an exemplary CRLS linear detector, in accordance with an embodiment of the invention.

FIG. 3B is a block diagram of another exemplary CRLS linear detector, in accordance with an embodiment of the invention.

FIG. 4A is a block diagram of an exemplary multiplexed CRLS linear detector, in accordance with an embodiment of the invention.

FIG. 4B is a block diagram of an exemplary multiplexed CRLS linear detector that computes a beam-forming matrix V, in accordance with an embodiment of the invention.

FIG. 5 is a block diagram of an exemplary CRLS linear detector utilizing a subcarrier normalizer, in accordance with an embodiment of the invention.

FIG. 6A is a block diagram of an exemplary systolic array that may be utilized to penalize the off-diagonal elements of the tap-weight matrix W, in accordance with an embodiment of the invention.

FIG. 6B is a block diagram of another exemplary detector that may be utilized to penalize the off-diagonal elements of the tap-weight matrix W, in accordance with an embodiment of the invention.

### DETAILED DESCRIPTION OF THE INVENTION

Certain embodiments of the invention may be found in a method and system for recursively detecting MIMO signals. The method may include receiving an RF vector signal comprising a plurality of transmitted subcarriers and determining an estimate of the received RF vector signal in a recursive manner on a per symbol or even a per sample basis. The method may also include normalizing a plurality of the transmitted subcarriers utilizing at least one subcarrier normalizer before performing the recursive algorithm. A systolic array may be used to process the multi-antenna received data in parallel and the state variables of the systolic array may be stored to a memory before processing the next subcarrier. The receiver and transmitter may be part of a MIMO system, where a beam-forming matrix may be communicated from the receiver to the transmitter, and the signals may conform to an OFDM standard.

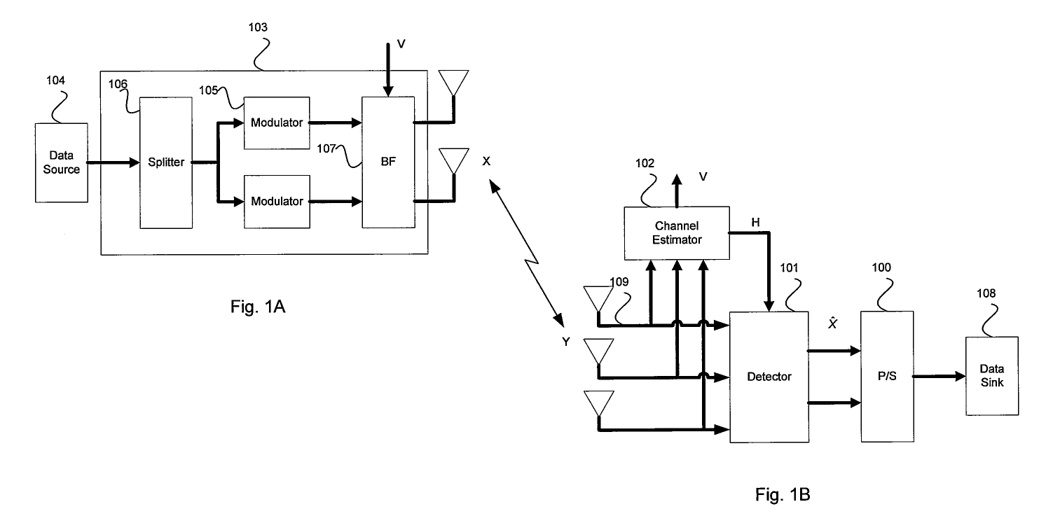

FIG. 1A is a block diagram of an exemplary system for transmitting OFDM signals, which may be utilized in connection with an embodiment of the invention. Referring to FIG. 1A, there is shown a data source 104 and an OFDM transmitter 103. The OFDM transmitter 103 comprises a splitter 106, a plurality of modulators 105, and a beamformer 107. The data source 104 may comprise suitable logic, circuitry and/or code that may enable generation of a digital bitstream. For example, the data source 104 may be a DSP within a 3G cellular telephone, where the output of the DSP may be, for example, digitized I/Q signals corresponding to digitized speech.

The splitter 106 may comprise suitable logic, circuitry and/or code that may enable partitioning of a high rate digital bit-stream from the data source 104 into several parallel low rate digital bitstreams. For example, the bitstream may be divided into two parallel bitstreams, or even dozens of parallel bitstreams. These parallel bitstreams may then be modulated by a plurality of modulators 105. The plurality of modulators 105 may comprise suitable logic, circuitry and/or code that may enable conversion of the digital bitstreams into an in-phase and quadrature phase (I/Q) representation of the signal and may also comprise suitable logic, circuitry and/or code that may enable up-converting the I/Q signal to an RF frequency. The output of the plurality of modulators 105 may be input into a beamformer 107.

The beamformer 107 may comprise suitable logic, circuitry and/or code that may enable transmission of a plurality of RF signals via an array of transmitters that control the directionality of, or sensitivity to, a radiation pattern. The beamformer 107 may accomplish this by creating beams and nulls in the radiation pattern of several antennas. This may effectively increase the transmission gain in the direction the signal may be sent. In this regard, a beam-forming matrix V may be communicated to the beamformer 107 from a receiver receiving the transmissions. The beam-forming matrix may be thought of as a feedback signal that the beamformer 107 may utilize to maximize the signal strength received at the receiver.

FIG. 1B is a block diagram of an exemplary system for receiving OFDM signals, in accordance with an embodiment of the invention. Referring to FIG. 1B, there is shown a plurality of receivers 109, a channel estimator 102, a detector 101, a parallel to serial converter 100 and a data sink 108. The plurality of receivers 109 may comprise suitable logic, circuitry and/or code that may enable reception of a plurality of OFDM signals.

The channel estimator 102 may comprise suitable logic, circuitry and/or code that may enable computation of a channel matrix H and a beam-forming matrix V. The channel matrix H may be of size N_{TX} by N_{RX} where N_{TX} and N_{RX} may correspond to the number of transmit and receive antennas respectively. The channel matrix H may be computed by analyzing data bursts preceded by a known preamble. By comparing the known preamble to the preamble received by the receiver, the channel estimator 102 may determine the distortion produced by the channel. The estimated channel matrix H may be updated on the basis of payload signal samples using appropriate tracking algorithms. Therefore, the detector 101 may be informed of abrupt channel changes such as the ones experienced in mobile communication channels.

The beam-forming matrix V may be a measure of the relative signal characteristics at the plurality of receivers 109. For example, V may represent the signal strength and signal delay of the signals received. The beam-forming matrix V may be communicated back to a beamformer 107 within, for example, an OFDM transmitter 103. This may enable the OFDM transmitter 103 to compensate the transmission by, for example, changing the gain and/or delay of the signals transmitted.

The detector 101 may comprise suitable logic, circuitry and/or code that may enable equalizing the received signal. In this regard, the channel matrix H may be input into the detector 101 and utilized to compensate for the effects of distortion on the received signal. The detector may have a plurality of outputs corresponding to the plurality of RF transmitted signals that make up the OFDM signal. These outputs may then be input into the parallel to serial converter 100.

The parallel to serial converter 100 may comprise suitable logic, circuitry and/or code that may enable the combination of several parallel low rate digital bit-streams in one high rate digital bit-stream. In this regard, signals input into the parallel to serial converter 100 may be equivalent to the signals output from the splitter 106 in the OFDM transmitter 103. The output of the parallel to serial converter 100 may correspond the signal input into the splitter 106 in an OFDM transmitter 103 and may be input into the data sink 108.

The data sink 108 may comprise suitable logic, circuitry and/or code that may enable reception of a digital bitstream. For example, the data sink 108 may be a DSP within a 3G cellular telephone. The data sink 108 may input signals from the parallel to serial converter 100 and may convert those signals to, for example, audio signals or data for applications.

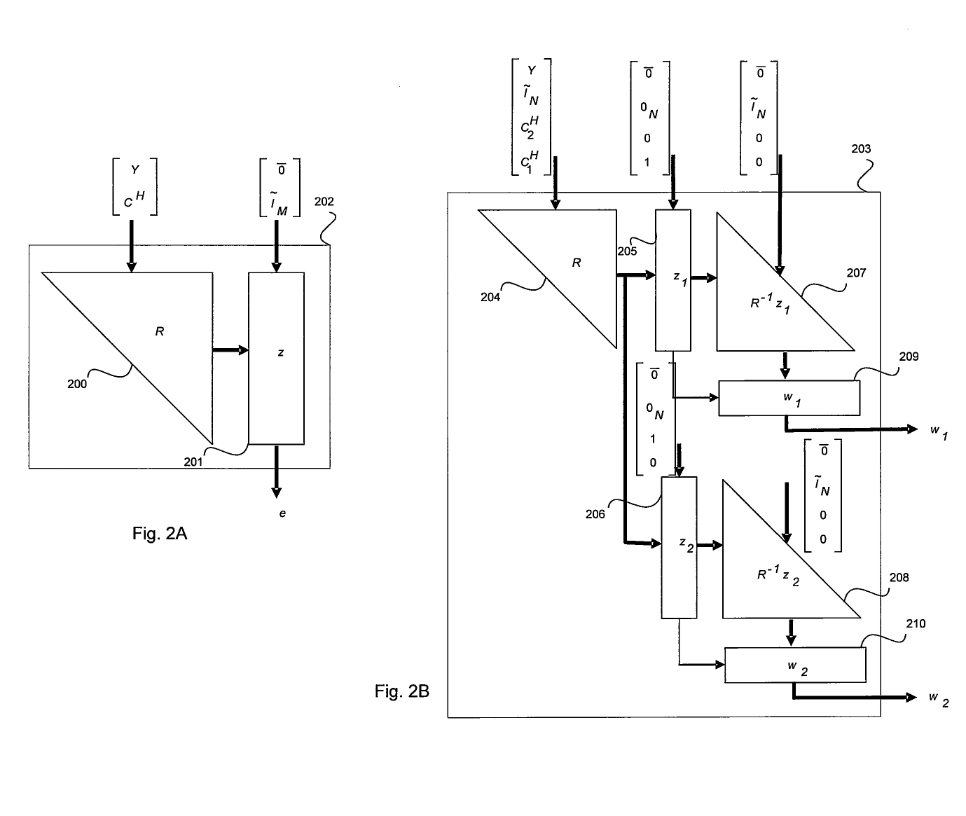

FIG. 2A is a block diagram of an exemplary systolic array, which may be utilized in connection with an embodiment of the invention. The systolic array may comprise an array of separate processing cells that may be coupled to one another. Each processing cell may comprise a memory and computations within the cells may be clocked. For example, during a first clock cycle data in any given cell may be transferred to an adjacent cell. Then a computation may be performed on that data in the adjacent cell. The result of the computation may be held until the next clock cycle at which time the result may be transferred to the next adjacent cell. The cells in the systolic array may be arranged to perform a wide range of functions. For example, the cells of the systolic array may be arranged to compute the recursive least means square (RLS) algorithm. In this regard, the systolic array in FIG. 2A may be utilized to minimize an error vector e that corresponds to the difference between a desired signal and the actual signal.

FIG. 2B is a block diagram of an exemplary systolic array that produces weight vectors, which may be utilized in connection with an embodiment of the invention. The systolic array may comprise an array of separate processing cells that may be coupled to one another. Each processing cell may comprise a memory and computations within the cells may be clocked. For example, during a first clock cycle data in any given cell may be transferred to an adjacent cell. Then a computation may be performed on that data in the adjacent cell. The result of the computation may be held until the next clock cycle at which time the result may be transferred to the next adjacent cell. The cells in the systolic array may be arranged to perform a wide range of functions. For example, the cells of the systolic array may be arranged to compute the recursive least means square (RLS) algorithm. In this regard, the systolic array in FIG. 2A may be utilized to output the weight coefficients for a finite impulse response filter (FIR) that may minimize an error vector e that corresponds to the difference between a desired signal and the actual signal.

The channel matrix pseudo-inverse W may be computed by solving the following least squares minimization problem:

Minimize ∥W^{H}(y−H·\tilde{x}∥² so that W^{H}H approximates a diagonal matrix

where \tilde{x} is an a-priori estimate of x. P may be defined as P=W^{H}H with diagonal elements pᵢ, i=1, . . . , Nₜₓ the normalized powers of the columns hᵢ of the channel matrix H. If Nₜₓ=2 and i=1, then for the 1^{st} column w₁ of Wand the corresponding component e₁ of the optimal error e may correspond to the formula:

$${e}_{1} = {w}_{1}^{H} ( y - {h}_{1} {\tilde{x}}_{1} - {h}_{2} {\tilde{x}}_{2} ) = {p}_{1} Δ {x}_{1} + {n}_{1} , {n}_{1} = {w}_{1}^{H} ( {h}_{2} Δ {x}_{2} + n )$$

where Δxᵢ=xᵢ−\tilde{x}ᵢ, i=1, 2. Consequently the estimate may correspond to the formula:

\hat{x}₁=\tilde{x}₁+e₁/p₁

The estimation error may be n₁/p₁ and its variance may depend on the ratio of the off-diagonal element w₁^{H}h₂ of P versus the diagonal one p₁, as well as the error of the a-priori estimate of x₂. The a-priori estimate \tilde{x} may be obtained for example by the formula:

x=W^{H}y

The optimal error may be obtained by formulating the least squares minimization problem in a recursive manner (constraint recursive least squares—CRLS) as follows:

Minimize ∥B\tilde{Y}w∥² with respect to w, subject to w^{H}h₁=pᵢ

where

$$\tilde{Y} = Y - {\sum }_{j} {\tilde{X}}_{j} {h}_{j}^{T}$$

represent's an observation vector free of data content, \tilde{X}ⱼ, j=1, . . . , N, represent the a-priori estimates of the j^{th} element of x across time and B is a diagonal matrix imposing exponential forgetting.

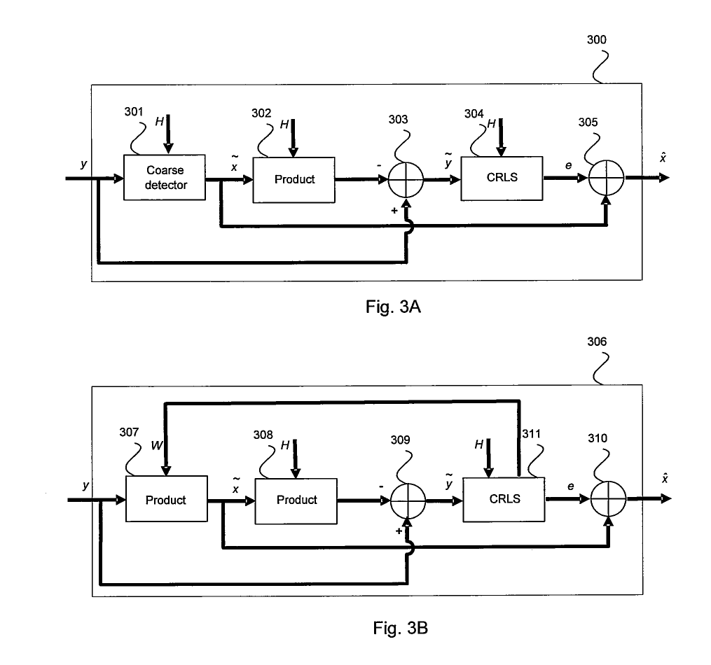

FIG. 3A is a block diagram of an exemplary CRLS linear detector, in accordance with an embodiment of the invention. Referring to FIG. 3A, there is shown a course detector 301, a product block 302, two summing blocks 303 and 305, and a CRLS block 304. The course detector 301 may comprise suitable logic, circuitry, and/or code that may enable computing an estimate of a transmitted signal \hat{X} from a received signal Y and a channel matrix H. In this regard, the CRLS linear detector shown in FIG. 3A may be capable of solving the minimization problem described above. The channel matrix H may be input from a channel estimator 102 (FIG. 1B). The accuracy of \hat{X} may be dependent on, for example, how often a preamble is present in a data burst, as well as the tracking algorithm used for H.

The product block 302 and summing block 303 may comprise suitable logic, circuitry, and/or code that may enable computing a content-free observation. The prior estimate \tilde{X} of the transmitted signal may be input into the product block 302 and the current value of the received signal Y may be input in the summing block 303. The output of the summing block 303 may correspond to the following formula:

$$\tilde{Y} = Y - {\sum }_{j} {\tilde{X}}_{j} {h}_{j}^{T}$$

where \tilde{Y} is the content-free observation vector across time, \tilde{X}ⱼ, j=1, . . . , Nₜₓ represents the a-priori estimates of the j^{th} element of X across time, and hⱼ is the normalized power of column j of the channel matrix H.

The CRLS block 304 may comprise suitable logic, circuitry, and/or code that may enable computing a constrained recursive least mean square algorithm (CRLS). In this regard, the CRLS block 304 may comprise the systolic array show in FIG. 2A. The CRLS block 304 may input the prior estimate of the received signal \tilde{Y} from the summing block 303 and the channel estimate H from the channel estimator 102 (FIG. 1B). The CRLS block 304 may output an error vector e that may correspond to the error between the least squares estimate \hat{X} of the transmitted signal and the prior estimate \tilde{X}. The error e may then be added to the prior estimate of the transmitted signal \tilde{X} via a summing block 305 to arrive at a current estimate of the transmitted signal \hat{X}. In this manner, the CRLS linear detector shown in FIG. 3A may be capable of compensating for channel distortions when the transmitter and receiver are not stationary. This may facilitate, for example, receiving OFDM signals in a mobile device, such as a cellular telephone.

FIG. 3B is a block diagram of another exemplary CRLS linear detector, in accordance with an embodiment of the invention. Referring to FIG. 3B, there is shown a first and second product block 307 and 308, two summing blocks 309 and 310, and a CRLS block 311. The first product block 307 may comprise suitable logic, circuitry, and/or code that may enable computing an estimate \tilde{X} of the transmitted signal from a received signal Y and tap-weight coefficients W. In this regard, the tap-weight coefficients W may correspond to those tap-weights that may enable an FIR to compensate for the effects of stationary or non-stationary channel distortion. The accuracy of \tilde{X} may be dependent on, for example, how often a preamble is present in a data burst. In this regard, the tap-weight coefficients W alone may be utilized to compensate for signal distortion when, for example, the accuracy of the channel estimate.

The product block 308 and summing block 309 may comprise suitable logic, circuitry, and/or code that may enable computing an observation vector free of data content. The prior estimate of the transmitted signal \tilde{X} may be input into the product block 308 and the current value of the received signal Y may be input in the summing block 309. The output of the summing block 309 may correspond to the following formula:

$$\tilde{Y} = Y - {\sum }_{j} {\tilde{X}}_{j} {h}_{j}^{T}$$

where \tilde{Y} is the content-free observation vector across time, \tilde{X}ⱼ, j=1, . . . , Nₜₓ represents the a-priori estimates of the j^{th} element of X across time, and hⱼ is the normalized power of column j of the channel matrix H.

The CRLS block 311 may comprise suitable logic, circuitry, and/or code that may enable computing a constrained recursive least mean square algorithm (CRLS). In this regard, the CRLS block 311 may comprise the systolic array shown in FIG. 2B. The CRLS block shown in FIG. 3B may input the content-free signal \tilde{Y} from the summing block 309 and the channel estimate H from the channel estimator 102 (FIG. 1B). The CRLS block 311 of FIG. 3B may output tap-weight coefficients for an FIR filter and an error vector e that may correspond to the error between the least squares estimate \hat{X} of the transmitted signal and the prior estimate \tilde{X}. The tap-weight coefficients W may be input into the first product block 307 and may be used to derive the prior estimate \tilde{X} of the transmitted signal.

As an alternative, the CRLS block 311 of FIG. 3B may comprise the systolic array shown FIG. 2A. In this case, the tap-weight coefficients W may be computed by stealing cycles from the normal CRLS processing. For example, the tap-weight coefficients W may be derived by stealing N_{RX} cycles from the normal CRLS processing and inputting an identity matrix into the array.

The error e may be added to the prior estimate of the transmitted signal X via a summing block 310 to arrive at a current estimate of the transmitted signal \tilde{X}. In this manner, the CRLS linear detector shown in FIG. 3B may be capable of compensating for channel distortions when the transmitter and receiver are not stationary. This may facilitate, for example, receiving OFDM signals in a mobile device, such as a cellular telephone.

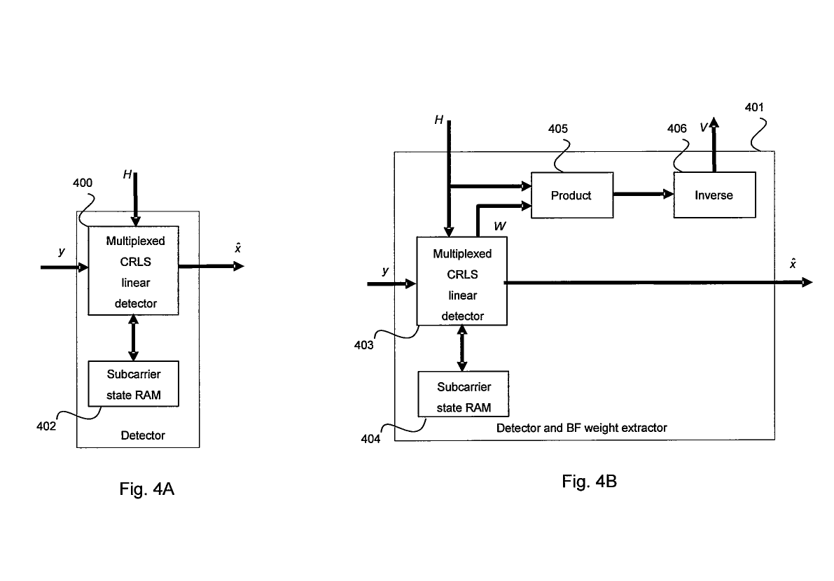

FIG. 4A is a block diagram of an exemplary multiplexed CRLS linear detector, in accordance with an embodiment of the invention. Referring to FIG. 4A, there is shown a multiplexed detector 400 and a subcarrier state RAM 402. The multiplexed detector 400 may comprise suitable logic, circuitry, and/or code that may enable the independent estimation of the transmitted OFDM subcarriers in a transmission system employing OFDM signaling. In this regard, the multiplexed detector 400 may comprise the detector shown in FIG. 3A or FIG. 3B. The subcarrier state RAM 402 may comprise suitable logic, circuitry, and/or code that may enable storing a plurality of state values associated with the detection of a particular subcarrier.

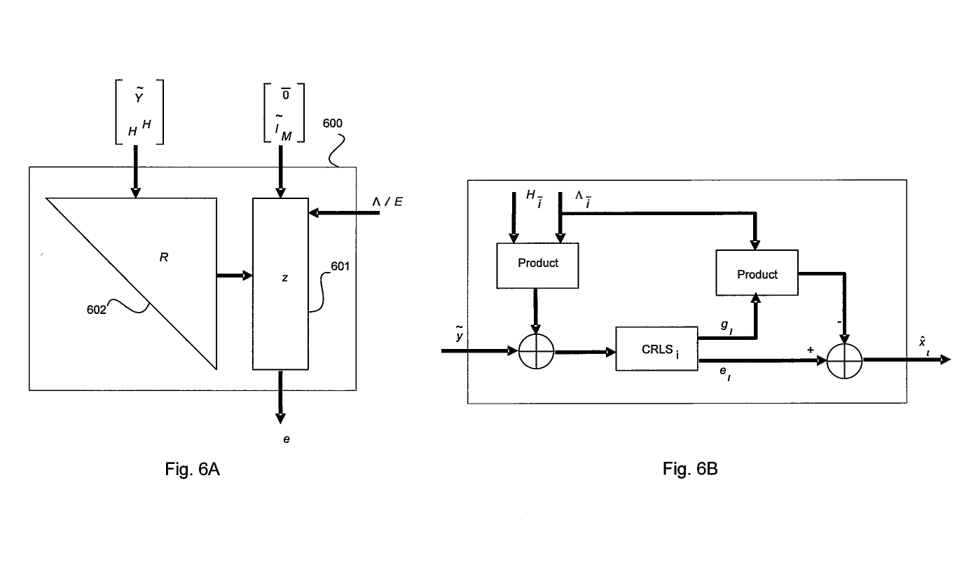

In operation, each of the CRLS detectors shown in FIG. 3A or FIG. 3B may first process a first subcarrier and may then be initialized with various state parameters associated with that subcarrier. For example, the state parameters W, H, \tilde{X}, \tilde{Y}, e, and \hat{X} may be retrieved from the subcarrier state RAM 402. In addition, the internal state parameters of the systolic array shown in FIG. 2A, FIG. 2B, or FIG. 6A may be retrieved from the subcarrier state RAM 402 as well. The CRLS detectors may then compute a new estimate of the transmitted signal \hat{X} corresponding to the first subcarrier. Once the computation has finished, the various state parameters may then be stored back into the subcarrier state RAM 402. The CRLS detectors may then process a second subcarrier and may be initialized with the various state parameters associated with that antenna. The CRLS detectors may then compute a new estimate of the transmitted signal \hat{X} corresponding to the second subcarrier. The operation may continue until all the subcarrier signals may have been analyzed.

FIG. 4B is a block diagram of an exemplary multiplexed CRLS linear detector that computes a beam-forming matrix V, in accordance with an embodiment of the invention. Referring to FIG. 4A, there is shown a multiplexed detector 403, a subcarrier state RAM 404, a product block 405, and an inverter 406. The multiplexed detector 403 may comprise suitable logic, circuitry, and/or code that may enable estimating a transmitted signal \hat{X} from a plurality of receivers. In this regard, the multiplexed detector 403 may comprise the detector shown in FIG. 3B. The subcarrier state RAM 404 may comprise suitable logic, circuitry, and/or code that may enable storing a plurality of state values associated with the detection of a particular received signal Y. The product block 405 and inverter 406 may comprise suitable logic, circuitry, and/or code that may enable computing a beam-forming matrix V based on the channel matrix H and the tap-weight coefficients W.

In operation, the detector shown in FIG. 4B may first process a first OFDM subcarrier and may then be initialized with various state parameters associated with that subcarrier. For example, the state parameters W, H, \tilde{X}, \tilde{Y}, e, and \hat{X} may be retrieved from the subcarrier state RAM 404. In addition, the internal state parameters of the systolic array shown in FIG. 2A, FIG. 2B, or FIG. 6A may be retrieved from the subcarrier state RAM 402 as well. The detector may then compute a new estimate of the transmitted signal \hat{X} based on the received signal associated with the first subcarrier. Once the computation has finished, the various state parameters may then be stored back into the subcarrier state RAM 404. The detector may then resume processing of a second subcarrier and may be initialized with the various state parameters associated with that subcarrier. The detector may then compute a new estimate of the transmitted signal \hat{X} based on the received signal associated to the second subcarrier. The operation may continue until all the subcarrier signals may have been analyzed.

Additionally, the tap-weight coefficients W and the channel matrix H may be utilized to obtain a beam-forming matrix a beam-forming matrix V. The beam-forming matrix V may be communicated back to the original transmitter and used in the beamformer 107 within the transmitter. For example, if u is the input to the beamformer 107, x=V·u where x is the transmitted signal. Therefore, the detector may need to produce matrices W and V that minimize the error: e=W^{H}y−u=W^{H}(Hx+n)−V⁻¹x. The optimal selection of V may then be dictated by the equation V=(W^{H}H)⁻¹. Utilizing V in such a way may maximize the signal strength of the signal at the receiver.

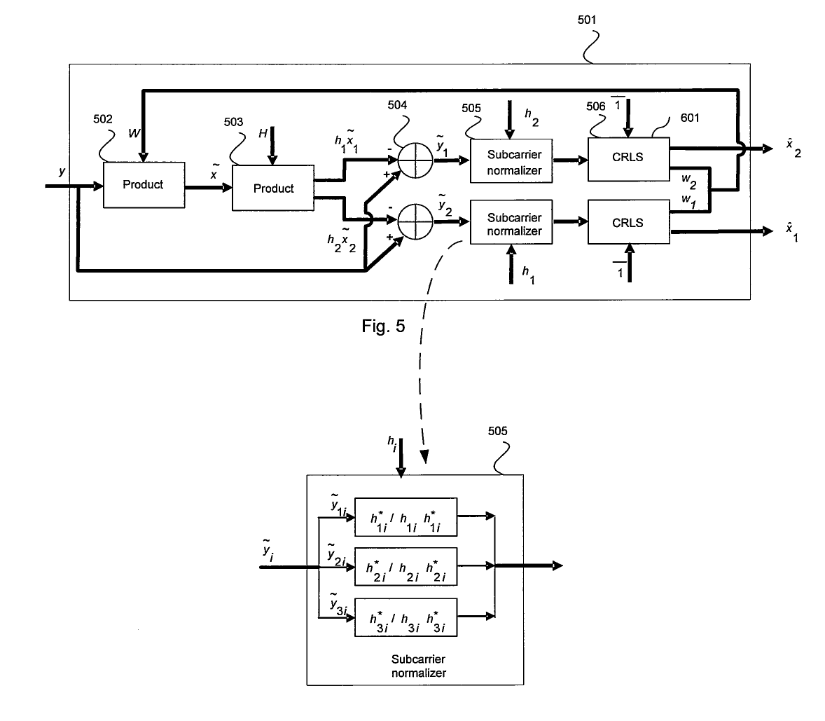

FIG. 5 is a block diagram of an exemplary CRLS linear detector utilizing a subcarrier normalizer, in accordance with an embodiment of the invention. Referring to FIG. 5, there is shown a first and second product block 502 and 503, two summing blocks 504, two subcarrier normalizers 505, and two CRLS blocks 506. The first product block 502 may comprise suitable logic, circuitry, and/or code that may enable computing an estimate \tilde{X} of the transmitted signal from a received signal Y and tap-weight coefficients W. In this regard, the tap-weight coefficients W may correspond to those tap-weights that may enable an FIR to compensate for the effects of stationary or non-stationary channel distortion. The accuracy of \tilde{X} may be dependent on, for example, the accuracy of the channel matrix estimate.

The product block 503 and summing blocks 504 may comprise suitable logic, circuitry, and/or code that may enable computing prior estimates \tilde{Y}₁ and \tilde{Y}₂ of the received signals at a plurality of antennas. In this regard, the number of received signal estimates \tilde{Y} may be equal to the number of antennas. The prior estimates \tilde{X} of the transmitted signal may be input into the product block 503 along with the channel matrix H, and the current value of the received signal Y may be input into the summing blocks 504. The estimates of the received signals \tilde{Y}₁ and \tilde{Y}₂ may be output from the summing blocks 504. The output of the summing blocks 504 may correspond to the following formula:

$${\tilde{Y}}_{j} = Y - {\sum }_{i \neq j} {\tilde{X}}_{i} {h}_{i}^{T}$$

where \tilde{Y}ⱼ, j=1, . . . Nₜₓ represent a-priori estimates of the j^{th} element of X across time, and hⱼ is the normalized power of column j of the channel matrix H.

The subcarrier normalizers 505 may comprise suitable logic, circuitry, and/or code that may enable removing the subcarrier dependent information from the received signal estimates. In this regard, the number of subcarrier normalizers 505 may be equal to the number of antennas on the receiver. Utilizing multiple subcarrier normalizers 505 may enable the common use of the CRLS block 506 by all OFDM subcarriers. This may suggest an efficient implementation, while at the same time the CRLS may be updated on a sample-by-sample basis and this may in turn enable the channel changes to be followed very closely by the detector. Furthermore, the utilization of the subcarrier normalizers 505 may also render the initial preamble based tap-weights estimates more reliable.

The CRLS blocks 506 may comprise suitable logic, circuitry, and/or code that may enable computing a constrained recursive least mean square algorithm (CRLS). In this regard, the CRLS block 506 may comprise the systolic array show in FIG. 2B. The CRLS blocks 506 may input the prior estimate of the normalized values of signals \tilde{Y}₁ and \tilde{Y}₂ from the subcarrier normalizers 505. Because the signals are normalized constraint evaluated by the CRLS blocks 506 may correspond to w^{H} 1̅_{Nrx}=pᵢ rather than w^{H}hᵢ=pᵢ. The CRLS block 506 may output tap-weight coefficients for an FIR filter and may also output estimates \tilde{X}₁ and \tilde{X}₂ of the transmitted signal components. The tap-weight coefficients W may be combined and then input into the first product block 502 and used to derive the prior estimate \tilde{X} of the transmitted signal.

As an alternative, the CRLS blocks 506 may comprise the systolic array shown FIG. 2A. In this case, the tap-weight coefficients W may be computed by stealing cycles from the normal CRLS processing. For example, the tap-weight coefficients W may be derived by stealing N_{RX} cycles from the normal CRLS processing and inputting an identity matrix into the systolic array.

In operation, the detector shown in FIG. 5 may be capable of compensating for channel distortions when the transmitter and receiver are not stationary. This may facilitate, for example, receiving OFDM signals by a MIMO detector within a mobile device, such as a cellular telephone. Utilization of multiple subcarrier normalizers 506 may also enable the constraint within the CRLS block 506 to be updated on a sample-by-sample basis and this may in turn enable the channel changes to be followed in a more efficient way by the detector. The utilization of the subcarrier normalizers 505 may also render the initial values for the tap-weights more reliable.

FIG. 6A is a block diagram of an exemplary systolic array that may be utilized to penalize the off-diagonal elements of the product matrix P=W^{H}H, in accordance with an embodiment of the invention. Referring to FIG. 6A, there is shown an R-block 602 and a z-block 601. The tap-weight matrix W may be computed in a way so that the off-diagonal elements of P are penalized. Let pᵢ, i=1, . . . , Nₜₓ be the diagonal elements of P. In particular, for Nₜₓ=2 and i=1 the following minimization problem may be solved:

Minimize ∥B\tilde{Y}w∥²+λ₂∥w^{H}h₂∥² with respect to w, subject to w^{H}h₁=p₁

where λ₂ is a positive constant and B is a diagonal matrix imposing exponential forgetting. It may be shown that:

w₁=p₁R⁻¹\tilde{z}₁

where

$${\tilde{z}}_{1} = \frac{1}{{\vert {z}_{1} \vert}^{2} / {λ}_{2} + {\vert {z}_{1} \vert}^{2} {\vert {z}_{2} \vert}^{2} - {\vert {z}_{1}^{H} {z}_{2} \vert}^{2}} [ 1 / {λ}_{2} + {\vert {z}_{2} \vert}^{2} I - {z}_{2} {z}_{2}^{H} ] {z}_{1} .$$

R may correspond to the tri-matrix in a QR-decomposition of the input data matrix \tilde{Y} and zᵢ=R^{-H}hᵢ, i=1, 2. Consequently, the optimal error may correspond to the formula:

e₁=w^{H}\tilde{y}=p₁\tilde{z}₁^{H}R^{-H}\tilde{y}

This formula may be computed by the systolic array shown in FIG. 6A. The quantities R^{-H}\tilde{y} and \tilde{z}₁ may be computed by the R-block 602 and z-block 601. The computation of the vectors zᵢ, i=1, 2 may be identical to the computation performed by the systolic array shown in FIG. 2A and may take place in a parallel and pipelined manner. The estimate of x₁ may correspond to the formula:

\tilde{x}₁=\tilde{z}₁^{H}R^{-H}\tilde{y}

Another way of penalizing the off-diagonal elements of P may be expressed by the following minimization relationship:

Minimize ∥B\tilde{Y}w∥² with respect to w, subject to w_{H}h₁=p₁ and ∥w^{H}h₂∥≦ε

where ε has is a small positive value. It may be shown that the solution may be identical to the one of the previous problem where now λ₂ may be a function of ε and represented by the formula:

$${λ}_{2} = \frac{\vert {z}_{1} \vert}{\vert {z}_{1}^{H} {z}_{2} \vert ( \vert {z}_{1}^{H} {z}_{2} \vert + 1 / ɛ ) - {\vert {z}_{1} \vert}^{2} {\vert {z}_{2} \vert}^{2}}$$

The generalization of the above methods for Nₜₓ>2 may require simple algebraic manipulations. If the systolic array of FIG. 6A is used, the complexity of the processing elements in the z-block 501 may grow linearly with Nₜₓ.

FIG. 6B is a block diagram of another exemplary detector that may be utilized to penalize the off-diagonal of P, in accordance with an embodiment of the invention. The detector may comprise suitable logic, circuitry, and/or code that may enable computing an estimate \hat{X} of the transmitted signal where \hat{X} may be correspond to the formula:

$${\tilde{x}}_{1} = {\tilde{x}}_{1} + \frac{{e}_{1}}{{p}_{1}} - {λ}_{2} \frac{{z}_{1}^{H} {z}_{2}}{{\vert {z}_{1} \vert}^{2}} .$$

### This equation may be derived by first solving the minimization problem

Minimize ∥B(\tilde{Y}+ΛᵢHᵢ^{H})w∥² with respect to w, subject to w^{H}hᵢ=pᵢ

where H_{ī} denotes the channel matrix H without the i^{th} column, Λ_{ī} is Λ_{ī}= 1̅·[λ₁ . . . πᵢ₋₁ λᵢ₊₁ . . . λ_{Ntx}], 1̅ is a column vector with unit elements of length equal to the length of the input matrix \tilde{Y} and λᵢ=1, . . . , Nₜₓ are positive constants. If Nₜₓ=2 and i=1, the resulting weight vector w₁ may give an error equal to:

$${e}_{1} = {w}_{1}^{H} ( \tilde{y} + {λ}_{2} {h}_{2} ) = {p}_{1} Δ {x}_{1} + {λ}_{2} {w}_{1}^{H} {h}_{2} + {n}_{1} , {n}_{1} = {w}_{1}^{H} ( {h}_{2} Δ {x}_{2} + n )$$

It may be shown that:

$${w}_{1}^{H} {h}_{2} = {p}_{1} \frac{{z}_{1}^{H} {z}_{2}}{{\vert {z}_{1} \vert}^{2}}$$

and that \hat{X} therefore corresponds to the formula:

$${\tilde{x}}_{1} = {\tilde{x}}_{1} + \frac{{e}_{1}}{{p}_{1}} - {λ}_{2} \frac{{z}_{1}^{H} {z}_{2}}{{\vert {z}_{1} \vert}^{2}}$$

The generalization to Nₜₓ>2 may be straightforward and may imply regular computation structures.

Another embodiment of the invention may provide a method for performing the steps as described herein for recursively detecting MIMO signals. For example, the detector 101 shown in FIG. 1B may be configured to receive at time instant n an RF vector Yₙ, an estimate of the channel matrix Hₙ and a previous state information Sₙ₋₁, where the state information may represent a pseudo-inverse of the channel matrix Hₙ₋₁ or an RLS state vector, or a lattice representation associated to the channel matrix Hₙ₋₁, while the said detector may be configured to produce at time instant n a data content estimate \hat{X}ₙ and a current state information Sₙ: └\hat{X}ₙ,Sₙ┘=f(Yₙ,HₙSₙ₋₁) where f( ) may be a recursive operation. The received RF vector signal may comprise one or more transmitted subcarriers and the data content may be estimated by performing an RLS algorithm 304 on each of the transmitted subcarriers. A subcarrier normalizer 505 (FIG. 5) may be utilized to normalize the transmitted subcarriers before they may be processed by the RLS algorithm 506 (FIG. 5) in which case the RLS algorithm 506 may update on a per sample basis. The RLS algorithm 304 and 506 may be constrained and may be performed by utilizing one of the systolic arrays shown in FIG. 2A, FIG. 2B, and FIG. 6A. State variables from the systolic array may be stored to a memory 402 (FIG. 4A) and 404 (FIG. 4B) before the system shown in FIG. 3A processes the next subcarrier. The MIMO system may comprise a transmitter 103 with more than one antenna and a receiver 109 with more than one antenna and the signals may conform to an OFDM standard. In this regard, a beam-forming matrix V corresponding the received signal may be communicated from the receiver to the transmitter 103.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
receiving an RF vector signal via a plurality of antennas; and
determining data content carried by said received RF vector signal by performing a recursive algorithm on said RF vector signal and an estimated channel matrix.

2. The method according to claim 1, wherein said recursive algorithm is a constrained RLS algorithm.

3. The method according to claim 1, comprising performing said recursive algorithm utilizing a systolic array.

4. The method according to claim 3, comprising storing state variables of said systolic array to a memory before processing a next subcarrier of said plurality of said transmitted subcarriers.

5. The method according to claim 1, comprising normalizing said plurality of said transmitted subcarriers utilizing at least one subcarrier normalizer before performing said recursive algorithm

6. The method according to claim 5, wherein said recursive algorithm updates on a per sample basis.

7. The method according to claim 1, wherein said transmitted signal is transmitted via a transmitter utilizing a plurality of antennas.

8. The method according to claim 1, wherein said received RF vector signal comprises a plurality of transmitted subcarriers.

9. The method according to claim 1, wherein said RF vector signals conform to an OFDM standard.

10. The method according to claim 6, comprising communicating a beam-forming matrix corresponding to said received RF vector signal to a beamformer within said transmitter.

11. A machine-readable storage having stored thereon, a computer program having at least one code section for processing signals in a communication system, the at least one code section being executable by a machine for causing the machine to perform steps comprising:
receiving an RF vector signal via a plurality of antennas; and
determining an estimate of said received RF vector signal by performing a recursive algorithm on said RF vector signal and an estimated channel matrix.

12. The machine-readable storage according to claim 11, wherein said recursive algorithm is a constrained RLS algorithm.

13. The machine-readable storage according to claim 11, wherein said at least one code section comprises code that enables performing said recursive algorithm utilizing a systolic array.

14. The machine-readable storage according to claim 13, wherein said at least one code section comprises code that enables storing state variables of said systolic array to a memory before processing a next subcarrier of said plurality of said transmitted subcarriers.

15. The machine-readable storage according to claim 11, wherein said at least one code section comprises code that enables normalizing said plurality of said transmitted subcarriers utilizing at least one subcarrier normalizer before performing said recursive algorithm

16. The machine-readable storage according to claim 15, wherein said recursive algorithm updates on a per sample basis.

17. The machine-readable storage according to claim 11, wherein said transmitted signal is transmitted via a transmitter utilizing a plurality of antennas.

18. The machine-readable storage according to claim 11, wherein said received RF vector signal comprises a plurality of transmitted subcarriers.

19. The machine-readable storage according to claim 11, wherein said RF vector signals conform to an OFDM standard.

20. The machine-readable storage according to claim 16, wherein said at least one code section comprises code that enables communicating a beam-forming matrix corresponding to said received RF vector signal to a beamformer within said transmitter.

21. A system for processing signals in a communication system the system comprising:
one or more circuits that enables receiving an RF vector signal via a plurality of antennas; and
said one or more circuits enables determining an estimate of said received RF vector signal by performing a recursive algorithm on said RF vector signal and an estimated channel matrix.

22. The system according to claim 21, wherein said recursive algorithm is a constrained RLS algorithm.

23. The system according to claim 21, wherein said one or more circuits enables performing said recursive algorithm utilizing a systolic array.

24. The system according to claim 23, wherein said one or more circuits enables storing state variables of said systolic array to a memory before processing a next subcarrier of said plurality of said transmitted subcarriers.

25. The system according to claim 21, wherein said one or more circuits enables normalizing said plurality of said transmitted subcarriers utilizing at least one subcarrier normalizer before performing said recursive algorithm

26. The system according to claim 25, wherein said recursive algorithm updates on a per sample basis.

27. The system according to claim 19, wherein said transmitted signal is transmitted via a transmitter utilizing a plurality of antennas.

28. The system according to claim 21, wherein said one or more circuits enables receiving said received RF vector signal utilizing a plurality of antennas.

29. The system according to claim 21, wherein said RF vector signals conform to an OFDM standard.

30. The system according to claim 26, wherein said one or more circuits enables communicating a beam-forming matrix corresponding to said received RF vector signal to a beamformer within said transmitter.
